(19) United States
(12) Patent Application Publication
(10) Pub. No.: US 2023/0010020 A1
(43) Pub. Date: Jan. 12, 2023

(54) AUTOMATED TALENT USAGE RIGHTS NEGOTIATION & MANAGEMENT TOOL

(71) Applicant: Mark Willingham, Los Angeles, CA (US)

(72) Inventor: Mark Willingham, Los Angeles, CA (US)

(21) Appl. No.: 17/734,711

(22) Filed: May 2, 2022

Related U.S. Application Data
(60) Provisional application No. 63/155,047, filed on Mar. 1, 2021.

(51) Int. Cl. G06Q 50/18; G06Q 10/10

(52) U.S. Cl. CPC G06Q 50/188; G06Q 10/1053

(57) ABSTRACT

A system and method for managing usage rights, and autonomous creation of a usage rights and release agreement between a client and a talent for usage rights of job materials. The system includes an interface module for generating a client interface and a talent interface; a negotiation module for generating usage rights charge based on the price, the details of the client, and the details of the job; a contract module to generate a usage rights and release agreement based on the details of a talent, the usage rights charge, the details of the client, and the details of the job to; and generating a contract between the client and a talent based on the usage rights and release agreement.

### CROSS-REFERENCE TO RELATED APPLICATIONS

This application claims priority to the U.S. provisional patent application Ser. No. 63/155,047 filed on Mar. 1, 2021, which is incorporated herein by reference in its entirety.

### FIELD OF INVENTION

The disclosure relates to the field of online automated negotiation of usage rights, and more particularly, the present invention relates to an online automated system and method for negotiation and management of the usage rights.

### BACKGROUND

A contract refers to an agreement between two or more parties that defines and governs the rights and duties of the parties to the agreement. Contracts are legally binding, so it becomes important that a contract is carefully drafted. In businesses and professions, contracts are instrumental in most transactions. Both parties to a contract generally discuss the terms and conditions of the contract orally and then document them. The parties may also take the help of legal professionals, such as lawyers to draft the terms and conditions. However, not all humans have negotiation skills.

The professional industry that supports the concept of “booking talent” includes modeling, acting, musicians, influencers, appearances, photographers, content creators, and other performance, creations, or skill-based personnel. The booked talent is generally expected to provide a service in return for an agreed-upon compensation or, in some cases, the talent provides the service for free. In addition to the talent being compensated for a job, there is often a product that results from the service, referred to herein as Job Materials, that was performed by the talent. For example, models may be compensated for their time to prepare for and complete a photo shoot for a client, however, this does not necessarily provide the client that booked/hired the model with specific rights to use the photos or videos which were the result of the photoshoot (“Job Materials”). For example, if a Talent is hired for a photoshoot with an agreed-upon compensation of $1,000 for 4 hours of work, then the $1,000 paid is usually a compensation for the 4 hours of work provided by Talent and does not necessarily provide the client with the usage rights to the Job Materials. The caveat to this is if the Talent is of the legal age to enter a contract and signs a release that provides the client with usage rights for no additional compensation.

The negotiation and assignment of usage rights are generally handled manually by talent managers, agents, representatives, or the talent themselves, or by a parent or legal guardian if the talent is not legally able to personally enter a contract. The negotiation process can take considerable time as there are no guidelines that define any true standards for usage rights. Each job is different and the person negotiating on behalf of the talent must draw upon their experience to achieve the most favorable outcome. Thus, a lack of proper negotiation skills may lead to unfavorable outcomes for the parties in the contract later. The assistance of an attorney in drafting an agreement can be time-consuming and costly, and thus is not feasible most of the time, particularly for small value transactions.

A need is there for an automated system and method that can assist in drafting an agreement for usage rights or negotiating the terms and conditions of the contract.

### SUMMARY OF THE INVENTION

The principal object of the present invention is therefore directed to a system and method for automated Usage Rights Negotiation and Management.

It is another object of the present invention that the system and method can provide for automated negotiation between parties.

It is still another object of the present invention that the system and method can provide for automated management and renewal of contracts.

It is yet another object of the present invention that the system and method can reduce reliance on humans for usage rights negotiation and management.

It is a further object of the present invention that the system and method make the process of Usage Rights Negotiation and Management cost-effective.

It is still a further object of the present invention that the system and method allow for automated usage rights charge calculations.

It is yet a further object of the present invention that the system and method allow various usage rights pricing options to be presented to the client during the usage rights negotiation process.

It is an additional object of the present invention that the system and method allow for automated tracking of usage rights.

It is still an additional object of the present invention that the system and method allow leverage of smart contract.

In one aspect, disclosed is a system and method for negotiating, making, and managing usage rights and contracts. More particularly, the present invention relates to a usage rights negotiation and management tool that can automate the usage rights negotiation process, contractual binds the parties based on the usage rights agreement, tracks actual usage, and allows the clients to renew the contract at the end of the term.

In one aspect, the system can include three modules including a negotiation module, a contract module, and a rights governance module. The negotiation module automates the process of determining usage rights charge for the result of a talent booking. The contract module utilizes information obtained from the negotiation module as well as additional information to create a binding contract. The rights governance module tracks the usage rights contract.

In one aspect, disclosed are a system and method for managing usage rights, the method implemented within the system comprising a processor and a memory, the method comprising the steps of providing, by an interface module, a client interface and a talent interface; presenting, through the client interface, by a negotiation module implemented within the system and upon execution by the processor, system-generated pricing options; receiving, through the client interface, by the negotiation module, a price based on the system-generated pricing options, details of a client, and details of a job; determining, by the negotiation module, usage rights charge based on the price for creating the job materials, the details of the client, and the details of the job; processing, by a contract module implemented within the system and upon execution by the processor, details of a talent, the usage rights charge, the details of the client, and the details of the job to generate a usage rights and release agreement; presenting, through the talent interface, by the contract module, the usage rights and release agreement; and generating autonomously, by the contract module, a contract between the client and a talent. The method further comprises the steps of presenting, by the negotiation module, the usage rights charge, through the client interface for review by the client. The details of the client comprises nature of entity, turnover of entity, assignee of usage rights, duration for which the usage rights are needed, purpose, and territory of use. The usage rights and release agreement is processed based on a plurality of variables, the plurality of variable comprises usage rights amount, authorized sublicensee, talent name, job materials, license term, authorized purpose, territory, and release rights. The method further comprises the steps of managing, by a rights governance module, an implementation of the contract based on a plurality of parameters comprising compliancy, contract modification, and contract renewal.

### BRIEF DESCRIPTION OF THE DRAWINGS

FIG. 1 is a block diagram showing the architecture of the disclosed system, according to an exemplary embodiment of the present invention.

FIG. 2 shows a talent booking environment of the disclosed system, according to an exemplary embodiment of the present invention.

FIG. 3 is a flow chart showing an exemplary embodiment of the negotiation module, according to an exemplary embodiment of the present invention.

FIG. 4 is a flowchart showing an exemplary embodiment of the contract module, according to an exemplary embodiment of the present invention.

FIG. 5 is a flowchart showing an exemplary embodiment of the rights governance module, according to an exemplary embodiment of the present invention

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity and does not in itself dictate a relationship between the various embodiments and/or configurations discussed.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Although operations may be described as a sequential process, some of the operations may be performed in parallel, concurrently, and/or in a distributed environment, and with program code stored locally or remotely for access by single or multi-processor machines. In addition, in some embodiments, the order of operations may be rearranged without departing from the spirit of the disclosed subject matter.

In describing the invention, it will be understood that several techniques and steps are disclosed. Each of these has individual benefits and each can also be used in conjunction with one or more, or some cases all, of the other disclosed techniques. Accordingly, for the sake of clarity, this description will refrain from repeating every possible combination of the individual steps in an unnecessary fashion.

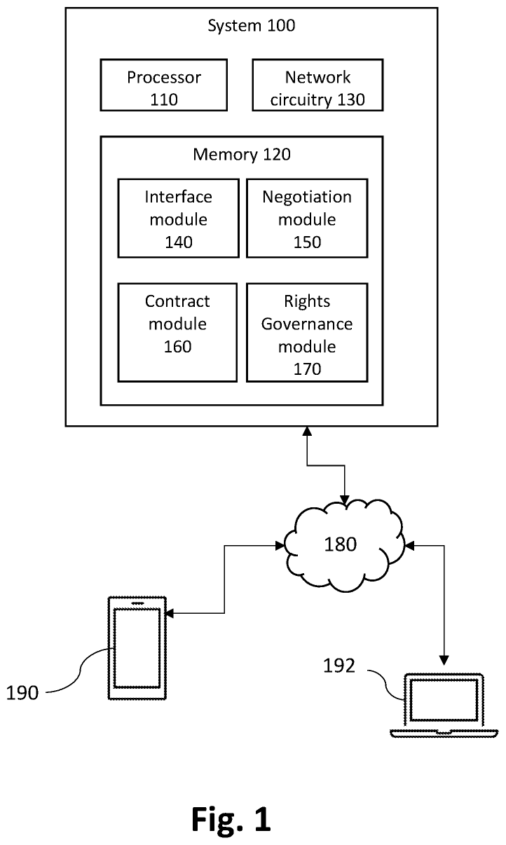

Disclosed is a system and method for negotiating, making, and managing contracts, which may also include smart contracts, in the talent booking industry. The disclosed system allows for usage rights negotiation and management by automating the usage rights negotiation process, contractual binds the parties based on the usage rights agreement, tracks actual usage, and allows the clients to renew the contract at the end of the term. Referring to FIG. 1 which shows an exemplary embodiment of the disclosed system 100 that can include a processor 110 and a memory 120. The processor can be any logic circuitry that responds to and processes instructions fetched from the memory and includes microprocessors. The memory may include one or more memory chips capable of storing data and allowing any storage location to be directly accessed by the processor. The system 100 may also include a network circuitry 130 that allows the disclosed system 100 to connect to two or more external devices through a network 180. The network can be wired or wireless. Moreover, the network can be secured or unsecured. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel, or a satellite band. The wireless network may also include any cellular network standards used to communicate among mobile devices, including but not limited to standards that qualify as 3G, 4G, or 5G.

The disclosed system through the network can connect to a client device 190 and a talent device 192. Thus, the disclosed system allows the clients and talents to collaborate through their devices. The devices can be a laptop, workstation computer, desktop, smartphone, tablet computer, client co outer device, and the like. While FIG. 1 shows the disclosed system 100 connected to a single client device and a single talent device through the network, however, one or more devices can connect to the disclosed system simultaneously or at different times. Moreover, it is understood that the different devices can connect through different networks and the same device can connect through more than one network. For example, an external device can connect through a combination of a wired and wireless network.

The disclosed system can be implemented in an environment of a single or multiple, logically grouped servers, the servers include cloud servers. According to an exemplary embodiment, the servers may be geographically dispersed. One or more of the servers can include an operating system platform, for example, Windows, Unix, Linux, or Mac.

The memory of disclosed system 100 can include an interface module 140, a negotiation module 150, contract module 160, and rights governance module 170. The modules can be software, a functional piece of code in one or more computer-readable languages, a set of instructions, and the like which upon execution by the processor can perform one or more steps of the disclosed methodology. The interface module 140 upon execution by the processor 110 can provide an interface on an external device for interacting with the disclosed system. The negotiation module 150 can upon execution of the processor automate the process of determining usage rights charge for the result of a talent booking. The contract module 160 upon execution by the processor can utilize information obtained from the negotiation module as well as additional information to create a binding contract. The rights governance module 170 upon execution by the processor can track the details of the usage rights contract.

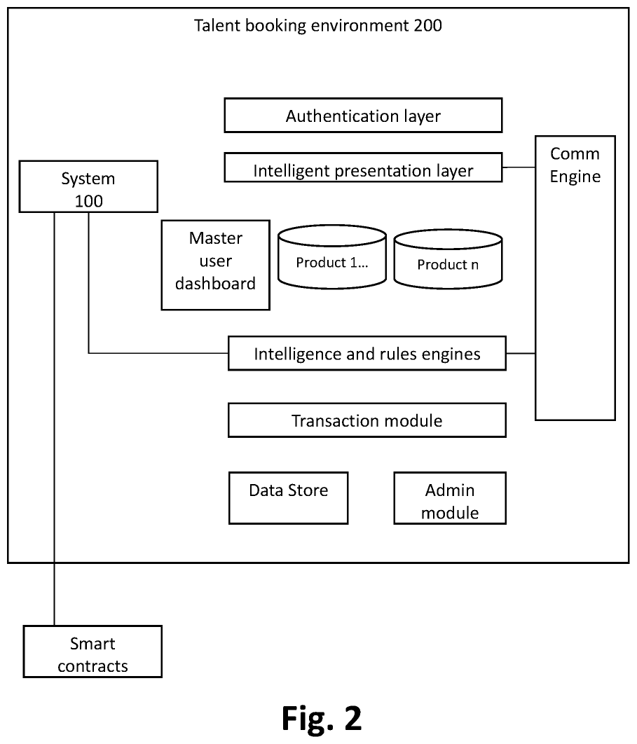

Referring to FIG. 2 which shows disclosed talent booking environment 200 of the disclosed system 100. The two parties in a contract are referred to herein as a client and a talent. The client wishes to book talent and pays/compensates for the services of the talent. The client can be the end-user of the Job Materials, including but not limited to producer, director, or manager, or sub-contractor hired by the end-user of the Job Materials, including but not limited to advertising agency, marketing agency, or photographer. The talent can be a skilled professional such as a musician, model, artist, actor, influencer, content creator, and photographer. The interface module 140 can provide a client interface on the client device. The interface module 140 can also provide a talent interface on the talent device.

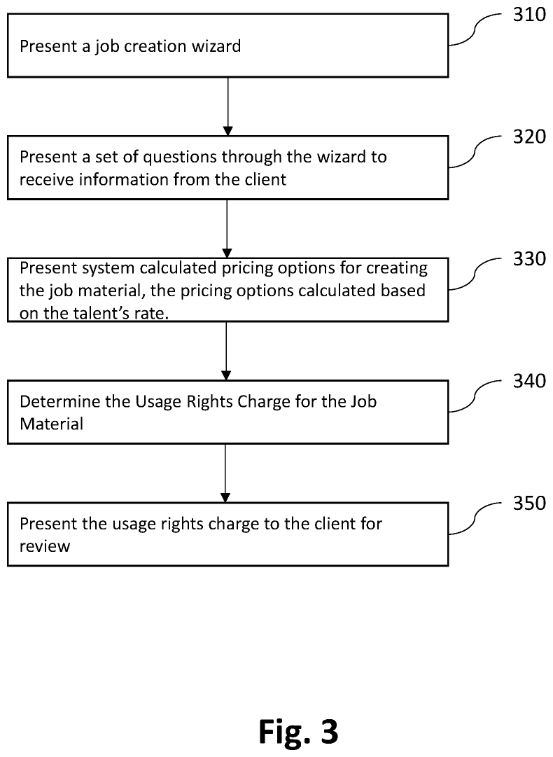

Referring to FIG. 3 which shows an exemplary embodiment of the negotiation module 150 for usage rights calculation. The client can be presented by the negotiation module with a job creation wizard through the client interface for communicating the requirements, at step 310. The negotiation module through the wizard can include a set of questions to receive information from the client about the job, and how, where, and for how long the job material will be used, at step 320. Through, the client interface, information about the client can be received by the negotiation module, the information includes the size (turnover) of the entity that will be using the job material. The negotiation module, through the client interface, can present system-generated pricing options for the job material, at step 330. Based on the information from the client through the client interface and the selection of price option from the system-generated pricing options, the negotiation module can determine the Usage Rights Charge for the Job Materials, at step 340. The negotiation module can present the usage rights charge as determined in the above step to the client through the client interface for review.

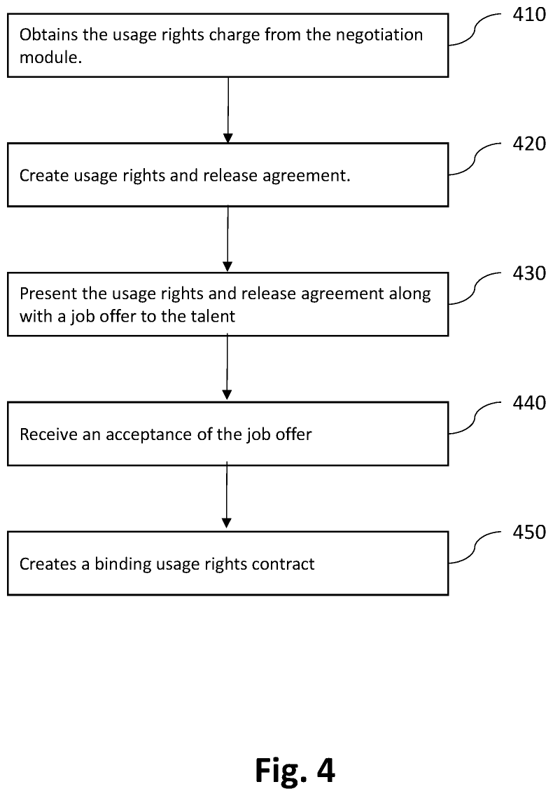

Referring to FIG. 4 which shows an exemplary embodiment of the contract module 160. The contract module 160 can automate the contract process between parties using either an online digital contract or blockchain smart contract, as shown in FIG. 2. First, the contract module can obtain the usage rights charge from the negotiation module, at step 410. The contract module can then autonomously create usage rights and release agreement, at step 420. The contract module 160 through the talent interface can present the usage rights and release agreement along with a job offer tied to the usage rights and release agreement to the talent, at step 430. The contract module, through the talent interface, can receive an acceptance of the job offer, at step 440. The contract module upon receiving the acceptance of the job offer which is also the acceptance of the usage rights and release agreement creates a binding usage rights contract, at step 450.

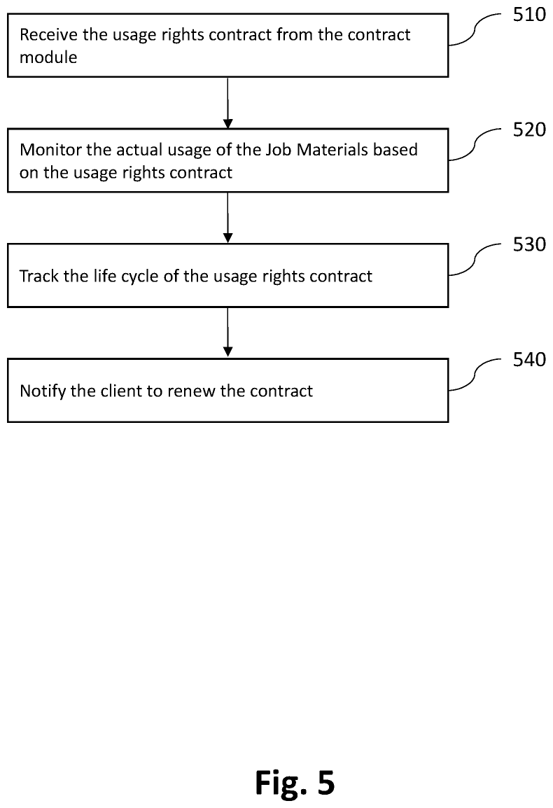

Referring to FIG. 5 which shows an exemplary embodiment of the Rights Governance Module 170. The Rights Governance Module 170 can receive the usage rights contract from the contract module, at step 510. When required, the rights governance module can autonomously monitor the actual usage of the Job Materials based on the usage rights contract, at step 520. This can be done by using digital fingerprints on the internet. The tracking can also be done manually, or manual steps can be taken while autonomous monitoring. The rights governance module can track the life cycle of the usage rights contract and can notify the client when it is time to renew, at steps 530 and 540. If the client wishes to renew the usage rights contract, the automated negotiation module and the contract module can facilitate the renewal process. The disclosed system can leverage blockchain smart contracts.

In certain implementations, the negotiation module can automate the process of determining usage rights charge for the result of a talent booking i.e., the Job Materials, based on predefined instructions and an algorithm that takes multiple variables into account. The variables can be but are not limited to Actual Job Amount: The amount paid to the talent based on the talent booking fee agreed to between the client and the talent; Assignee: The actual person or entity to whom the usage rights are being assigned; Authorized Sublicensee: The actual person or entity that booked the talent; License Term: The amount of time for which the Assignee would like to acquire usage rights; Authorized Purpose: The intended way(s) that the product resulting from the booking will be used; and Territory: The geographic location(s) in which the product resulting from the booking will be used.

The Contract Module can utilize the above information obtained from the Negotiation Module as well as additional information to create a binding contract, that can optionally leverage the security and benefits of smart contracts (blockchain), which includes but is not limited to Usage Rights Amount: The amount to be paid for the defined usage rights;

Authorized Sublicensee: The legal name of the actual person or entity that will be assigned usage rights; Talent Name: The name of the actual person who will be assigning the usage rights; Job Materials: All images, videos, information that will be covered by the usage rights contract; License Term: The amount of time for which the Assignee would like to acquire usage rights; Authorized Purpose: The intended way(s) that the Job Materials will be used; Territory: The geographic location(s) in which the product resulting from the booking will be used; Release Rights: The release of rights by the talent as defined by the contract; The Rights Governance Module can autonomously track the details of the usage rights contract using one or more parameters including; Compliancy: Automated process utilizing digital fingerprints to ensure the Job Materials are only being used for the purposes specified in the contract; Contract Modification: This allows for the Authorized Purpose and Territory to be expanded during the License Term and for any corresponding increased fees to be charged accordingly; and Contract Renewal: Automates the process for renewing and/or modifying the contract at the end of the License Term.

In one implementation, a user indicates that they want to acquire usage rights for specific photos or videos that have resulted from a talent booking. (An example could be a company/brand which hired a model for a marketing photoshoot. The model is paid for their time; however, this does not automatically provide usage rights of the resulting photos/video. The Usage Rights Negotiation Tool can allow the company to obtain the legal rights to use the photos/videos as they require.) The Usage Rights Negotiation Tool can prompt the user to provide required information such as the Company name to which the usage rights will be assigned, the Annual revenues of the company that will be using the job material, purposes for which the job material will be used, the geographic area in which the job material will be used, and any additional needs/requirements which are required to be in the contract (and may affect the price).

The Negotiation Tool can also provide various pricing options/fee rates from which the user can select. These price options are based on the length of time for which the company would like to retain the rights to use the job material. After selecting a price option, the Negotiation Tool can prompt the user for some additional information that is required for the usage rights contract and then generate the contract for distribution to all relevant parties. The system can utilize blockchain-based smart contracts for security and transparency purposes. The disclosed system can set a baseline value for negotiating the usage rights which can be based on standards, input from the talents, and certain variables such as skill level. In the event, the company has special/unique requirements, the talent can be notified for approval before the contract becomes legally binding.

The negotiations done by the disclosed system are transparent and automated based on pre-defined algorithms. The talent rate (which is set and controlled by the talent) can be used as a baseline value from which usage rights pricing options can be calculated. For example, if a talent has set their rate for a job at $1,000, then this is the amount that will be used as the baseline, in addition to other variables, for calculating the usage rights pricing options for the client. Unlike the traditional process which may take days, the disclosed system can complete the process in minutes. The disclosed system can manage the complete lifecycle starting from the beginning to the end of the contract term and then can also facilitate renewals.

In certain implementations, the disclosed system can be implemented for the Film/television/streaming industry for managing Residuals/royalty (“usage rights”) contracts for actors. Studios can leverage the Negotiation Tool by inputting custom variables which allow the system to generate royalty contracts for several types/levels of actors in a production. The system can circulate the contracts to all applicable parties for execution.

The disclosed system can be easily adapted to different industries by allowing the companies to define variables.

The disclosed system can be very easy and cost-effective to use for talents. For example, a photographer can upload photos along with base licensing rates. The system could then, based on similar variables used for the modeling industry, can calculate usage/licensing fees and then generate and manage the contracts. Thus, the talent can be paid according to industry standards, and both the client and the talent get a fair deal.

Non-fungible tokens are becoming popular for transacting digital assets. the disclosed system can be adapted for licensing of the NFTs. Owners of NFTs can leverage the Negotiation Tool to license NFTs to third parties. They can set a base rate for the NFT and then based on one or more predefined variables, the system can determine rate options and then create and circulate contracts for all applicable parties.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for managing usage rights, the method implemented within a system comprising a processor and a memory, the method comprising the steps of:
providing, by an interface module, a client interface and a talent interface;
presenting, through the client interface, by a negotiation module implemented within the system and upon execution by the processor, system-generated pricing options;
receiving, through the client interface, by the negotiation module, a price based on the system-generated pricing options, details of a client, and details of a job;
determining, by the negotiation module, usage rights charge based on the price, the details of the client, and the details of the job;
processing, by a contract module implemented within the system and upon execution by the processor, details of a talent, the usage rights charge, the details of the client, and the details of the job to generate a usage rights and release agreement;
presenting, through the talent interface, by the contract module, the usage rights and release agreement; and
generating autonomously, by the contract module, a contract between the client and a talent.

2. The method according to claim 1, wherein the method further comprises the steps of:
presenting, by the negotiation module, the usage rights charge, through the client interface for review by the client.

3. The method according to claim 1, wherein of the client comprises nature of entity, turnover of entity, assignee of usage rights, duration for which the usage rights are needed, purpose, and territory of use.

4. The method according to claim 1, wherein the contract is a smart contract.

5. The method according to claim 1, wherein the usage rights and release agreement is processed based on a plurality of variables, the plurality of variable comprises usage rights amount, authorized sublicensee, talent name, job materials, license term, authorized purpose, territory, and release rights.

6. The method according to claim 1, wherein the method further comprises the steps of:
managing, by a rights governance module, an implementation of the contract based on a plurality of parameters comprising compliancy, contract modification, and contract renewal.

7. A system for managing usage rights, the system comprising a processor and a memory, system configured to implement a method comprising the steps of:
providing, by an interface module, a client interface and a talent interface;
presenting, through the client interface, by a negotiation module implemented within the system and upon execution by the processor, system-generated pricing options;
receiving, through the client interface, by the negotiation module, a price based on the system-generated pricing options, details of a client, and details of a job;
determining, by the negotiation module, usage rights charge based on the price, the details of the client, and the details of the job;
processing, by a contract module implemented within the system and upon execution by the processor, details of a talent, the usage rights charge, the details of the client, and the details of the job to generate a usage rights and release agreement;
presenting, through the talent interface, by the contract module, the usage rights and release agreement; and
generating autonomously, by the contract module, a contract between the client and a talent.

8. The system according to claim 7, wherein the method further comprises the steps of:
presenting, by the negotiation module, the usage rights charge, through the client interface for review by the client.

9. The system according to claim 7, wherein the details of the client comprise nature of entity, turnover of entity, assignee of usage rights, duration for which the usage rights are needed, purpose, and territory of use.

10. The system according to claim 7, wherein the contract is a smart contract.

11. The system according to claim 7, wherein the usage rights and release agreement is processed based on a plurality of variables, the plurality of variable comprises usage rights amount, authorized sublicensee, talent name, job materials, license term, authorized purpose, territory, and release rights.

12. The system according to claim 7, wherein the method further comprises the steps of:
managing, by a rights governance module, an implementation of the contract based on a plurality of parameters comprising compliancy, contract modification, and contract renewal.
